(19) United States
(12) Patent Application Publication
(10) Pub. No.: US 2008/0040095 A1
(43) Pub. Date: Feb. 14, 2008

(54) System for Multiligual Machine Translation from English to Hindi and Other Indian Languages Using Pseudo-Interlingua and Hybridized Approach

(75) Inventors: R. Mahesh K. Sinha, Kanput (IN); Ajai Jain, Kanpur (IN)

Correspondence Address: MARJAMA MULDOON BLASIAK & SULLIVAN LLP, 250 SOUTH CLINTON STREET, SUITE 300, SYRACUSE, NY, 13202, US

(73) Assignee: Indian Institute of Technology and Ministry of Communication and Information Technology, Kanpur (IN)

(21) Appl. No.: 11/547,803

(22) PCT Filed: Apr. 6, 2004
(86) PCT No.: PCT/IN04/00093

§ 371 Date: Oct. 18, 2007

(51) Int. Cl. G06F 17/28

(52) U.S. Cl. 704/2; 704/E15.001

(57) ABSTRACT

The present invention relates to a method and system for translating a source language into a target language comprising the steps of:—identifying the nature of text extracted from a source document, - filtering and storing the text formatting and structure information of the extracted text,—selecting an appropriate text translation engine based on the nature of the extracted text, —using the text translation engine for analysing and translating the extracted text into an unformatted translated text, and—using the stored text formatting and structure information to process the unformatted text for obtaining a structured translated text document in the target language.

### FIELD OF THE INVENTION

The patent relates to the field of translation systems, more particularly it relates to a system and method for a multilingual translation system for translating from English to Hindi and other Indian languages using a pseudo-interlingua and hybrid approach.

### DESCRIPTION OF PRIOR ART

Language either in written or spoken forms is the most frequently used and effective means for communication. The only drawback being the difference in the language adopted by different group of people. There have been various means adopted by people to get around this hindrance. Multilingual dictionaries to human interpreters have been tried in the past. With the evolution of better computers, automated systems for translation have emerged which are constantly under research and subsequent betterment.

There are four basic approaches to machine translation, which are as follows:

Direct translation Approach: Using this approach, systems are designed in all details specifically for one particular pair of languages. The basic assumption is that the vocabulary and syntax of source language texts need not be analyzed any more than strictly necessary for the resolution of ambiguities, the correct identification of appropriate target language expressions and the specification of target language word order. Direct translation involves a series of stages commencing with word-for-word translation. Each stage refines the output from the previous stage by substituting translation for word-groups, by word-order changes etc. The majority of machine translation systems of the 1950's and 1960's were based on this approach. The direct translation approach suffers from being very rudimentary, requiring a lot of manual effort in building up the stages and has met with a very limited success for unidirectional specific pair of similar languages in specific domains.

Interlingual approach: In this approach, translation from source language to target language is performed in two distinct and independent stages. In the first stage source language texts are fully analysed and converted into an interlingual representations where it is assumed that all ambiguities have been resolved, and in the second stage this interlingual representation is used for synthesizing the target language text. The basic assumption of the interlingua method is that ‘meanings’ are language independent and so if meanings have once been extracted and represented, the target text generation is independent of the source language. Interlingual systems differ in their conceptions of an interlingual language, the extent of emphasis on semantic aspects and on syntactic aspects.

As the interlingua approach first translates the source language into an intermediate language which is a knowledge representation schema with complete disambiguation of the constituents of the source text, and that such a complete knowledge representation is not practically possible, the interlingua method has met with only a limited success.

Transfer approach: In this approach the source language is syntactically analyzed and transformed as per target language. The transfer will also be at the semantic and lexical level from source to the target language. The source language text is first converted into source language ‘transfer’ representations, and then these are converted into target language ‘transfer’ representations, and then finally, from these the final target language text forms are synthesized. The accuracy of the system depends upon the level of syntactic, semantic and lexical analysis and synthesis incorporated into the transfer representations used the system. Whereas the interlingual approach necessarily requires complete resolution of all ambiguities of source language texts so that translation should be possible into any other language, in the ‘transfer’ approach only those ambiguities inherent in the language in question are tackled. These systems have also been referred to as rule-based or knowledge-based MT systems.

The transfer approach requires crafting and validation of rules for syntactic, semantic and lexical transfer which has limitations of its own in terms of scalability besides being error-prone.

Example-based/Corpus-based/Statistics-based/Translation-memory based approaches: The fourth generation of approaches (post 1990) to overall machine translation strategy is to use examples of previously translated sentences. A sentence in source language is compared with pre-stored example sentences and the translation is obtained by picking up the closest example. The example-base and translation memory are created from bilingual corpora. The disambiguation is achieved by examples through distance computation and/or statistical analysis of constituent symbols and/or exact match from translation-memory.

The translation-memory are mostly used in restricted domains, Statistics-based systems require training on huge, good quality bilingual corpora for obtaining acceptable quality. The distance computation in example-based MT requires integration of a number of linguistic, pragmatic and statistical information, and adequate training to the system for weighting the constituent parts. The example-base may also become very large for achieving correct translation.

U.S. Pat. No. 6,278,967 provides “An automated system for generating natural language translation that are domain specific, grammar rule based and/or based on part of speech analysis”. The aforementioned patent uses keywords to identify the domain to which the text to be translated belongs. However, this approach has its drawbacks because the database of keywords might not be exhaustive enough to indicate the correct domain or the keywords in the document might not appear in the database. Further the aforementioned patent requires a lot of training for arriving at weights of lexical items and other constituents for selection of correct translation and desired accuracy of the translated output may not be achieved.

U.S. Pat. No. 5,426,583 refers to an “Automatic interlingual translation system”, that uses two intermediate languages with two stages of transfer. The method of the aforementioned patent suffers from all the drawbacks of the interlingual approach. Further, in this approach, an increase in the number of stages for performing the translation may lead to a loss of information and thereby, decrease the accuracy of the translated output.

European Patent no. 0,568,319,A2 refer to “Machine translation system” wherein a number of knowledge sources are used to create information repositories deduced from the source language text. These information repositories are used to generate information repositories for the target language which in turn are used by the target language generation module. The generator module uses constraint checker and tree builder to produce a set of candidate translations. The method of the aforementioned patent suffers from the drawbacks that it relies heavily on its ability to deduce complete and all necessary information repositories of the source and establish its correspondence in the target languages incorporating multiple interpretations which is not very practical. Further, the constraint checker and tree builder success is limited by the richness of the associated lexical information which cannot be assumed in a practical situation.

### OBJECT AND SUMMARY OF THE INVENTION

The main object of this invention is to obviate the above mentioned drawbacks of the prior art and provide a system and method for performing more accurate and faster machine translation primarily from English to a plurality of Indian languages using the pseudo interlingua and hybrid approach.

The second object of this invention is to provide an approach wherein translation from a source language to a group of languages belonging to a common family is more efficient.

A further object of this invention is that the system methodology be applicable to all Indian languages.

A yet another object of this invention is to provide a machine translation system that is scalable in performance and coverage of domains.

These and other objects are achieved by providing a system consisting of a number of modules that communicates with each other for translating texts written in English to Hindi and other Indian language at improved performance in terms of speed and accuracy.

In the instant invention, the concept of pseudo-interlingua is introduced wherein the source language is translated into an intermediate language that exploits the properties common to a family of target languages. In the pseudo-interlingual approach, the source language disambiguation is limited to the extent considered necessary for the family of target languages. Furthers the intermediate language can be tuned to the family of target languages, thereby improving the accuracy and the acceptability of the translated text.

In the instant invention, the concept of an Abstracted example-base is introduced wherein the raw examples are transformed into a more compacted abstract form. The abstracted example may contain ‘constants’ and ‘variable’ parts. For example, a raw example such as ‘Welcome to Delhi’ is abstracted to ‘Welcome to <city>’ (meaning that ‘you are welcome to the city’) whereas ‘Welcome to President’ is abstracted to ‘Welcome to <person>’ (meaning that ‘we welcome the person’). This way the size of the example-base is considerably reduced leading to improvement in accuracy and efficient search.

In the instant invention, the concept of an Interactive development of example-base is introduced wherein instead of relying on a bi-lingual parallel corpora whose quality and coverage may not be insured for development of example-base, the example-base is grown incrementally through user interaction. When the user finds that the translated output of the system is unsatisfactory, the input sentence is added to the example-base. With time, the number of examples added gets tapered indicating the extent of coverage.

In the instant invention, the concept of Hybridization is introduced wherein both the rule-based and example-based approaches are used in a judicious manner. While developing the translation system, first the rule-base is used for translation, and in case of unsatisfactory translation, the input sentence is entered as an example in the example-base. Whereas at the time of translation, the translation system first uses example-base for translation and in case it is below a specified matching threshold, the rule-base is invoked. This hybridization of rule-based and example-based approaches yields better accuracy and speed as it overcomes shortcomings of both of these approaches.

The machine translation system of this invention identifies the nature of the text to be translated and based on its nature, an appropriate main translation engine is invoked. The different translation engines differ in their grammar formalism and example base. A module in the identified main translation engine performs lexical analysis of each word of the input sentence using a hierarchical domain specific multilingual lexical database and in the process, it also identifies acronyms and unknown words. The hierarchical domain specific multilingual lexical database is organized as a Directed Acyclic Graph (DAG) linking domains with sub-domains.

An example-base storing frequently occurring phrasals and a rule-base is then used to translate English text to an intermediate form as per pseudo-interlingua where the word order is that of the family of target languages (Hindi or any other Indian language). The intermediate form is converted to Hindi or other Indian language by text-generators(s) using a number of target specific knowledge bases mostly derived from ‘KARAK’ theory of Sanskrit using Paninian framework. The unknown lexicons are transliterated into the script of the target language and suitably transformed as per their guessed part of speech. An automated post-editing is performed to achieve greater accuracy in form and style of presentation in the target language.

### BRIEF DESCRIPTION OF THE ACCOMPANYING DRAWINGS

For a more complete understanding of the present invention and the advantages thereof, the invention will now be described with the help of the accompanying drawings:

FIG. 1 is a block diagram of the computing system on which the present invention might be practiced.

FIG. 2 is a block schematic of the overall system of the present invention.

FIG. 3 shows a flow chart explaining the translation method of this invention.

FIG. 4 shows a block schematic of the module embodying main-translation engine of the present invention.

FIG. 5 shows an example of Domain Hierarchy in the form of DAG (Directed Acyclic Graph) used in the present in invention.

FIG. 6 shows a Block schematic of inputs used by the Text Generator Module for Hindi or other target Indian languages in the present invention.

FIG. 7 shows a Block schematic of Interactive method of Example-base creation.

### DETAILED DESCRIPTION OF THE INVENTION

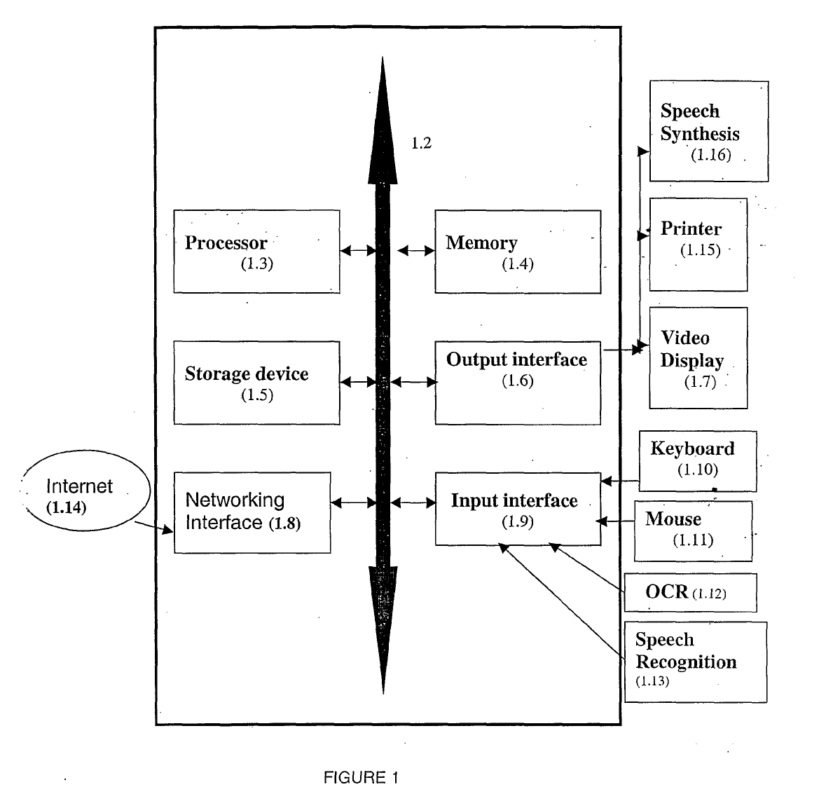

FIG. 1 is a block diagram that illustrates a typical device incorporating the invention. The device (1.1) consists of various subsystems interconnected with the help of a system bus (1.2). Each device (1.1) incorporates networking interface (1.8) that is used to connect the device to various networks such as a LAN, WAN or the Internet (1.14).

The instructions encoded in the various means used in the invention are stored in the storage device (1.5) and are transferred to the memory (1.4) through the internal communication bus (1.2) when the program is executed. The memory (1.4) holds the current instructions to be executed by the processor (1.3) along with their results. The processor (1.3) executes the instructions for translating the source document in the source language to the target language by fetching them from the memory (1.4). The processor (1.3) could be a microprocessor in case of a PC or a workstation, a dedicated semiconductor chip and the like. The keyboard (1.10), mouse (1.11) and other input devices such as Optical Character Recognition (1.12) and speech recognition system (1.13) connected to the computer system through the Input interface (1.9) are used for providing the user input such as adding entries in the example base, performing post editing on the translated document and the like.

The processor (1.3) executes the text extraction means for extracting the text to be translated and identifying its nature using a source language specific knowledge base. Following this, the text formatting-filtering means filter and store text formatting and structure information of the text. Then, the Text translation engine invoking means cause the instructions encoded in the suitable text translation engine identified based on the nature of the text to be executed for analysing and translating the extracted text into an unformatted translated text. The unformatted translated text is formatted into a structured form for obtaining the translated text in the target language by the text formatting means. The structured translated text in the target language is displayed to the user through the video display (1.7), printed using a printer (1.15) and/or converted to speech through speech synthesizer (1.16) connected to the computing device through the output interface (1.6) for carrying out post-editing if necessary.

Those of ordinary skill in the art will appreciate that the means herein described are instructions for operating on the computing system. The means are capable of existing in an embedded form within the hardware of a computing system or may be embodied on various computer readable media. The computer readable media may take the form of coded formats that are decoded for actual use in a particular information processing system. Computer program means or a computer program in the present context mean any expression, in any language, code, or notation, of a set of instructions intended to cause a system having information processing capability to perform the particular function either directly or after performing either or both of the following:

a) conversion to another language, code or notation

b) reproduction in a different material form.

The depicted example in FIG. 1 is not meant to imply architectural limitations and the configuration of the incorporating device of the said means may vary depending on the implementation. The invention can be realized in hardware, software, or a combination of hardware and software. Any kind of computer system or other apparatus adapted for carrying out the means described herein can be employed for practicing the invention. A typical combination of hardware and software could be a general purpose computer system with a computer program that when loaded and executed, controls the computer system such that it carries out the means described herein.

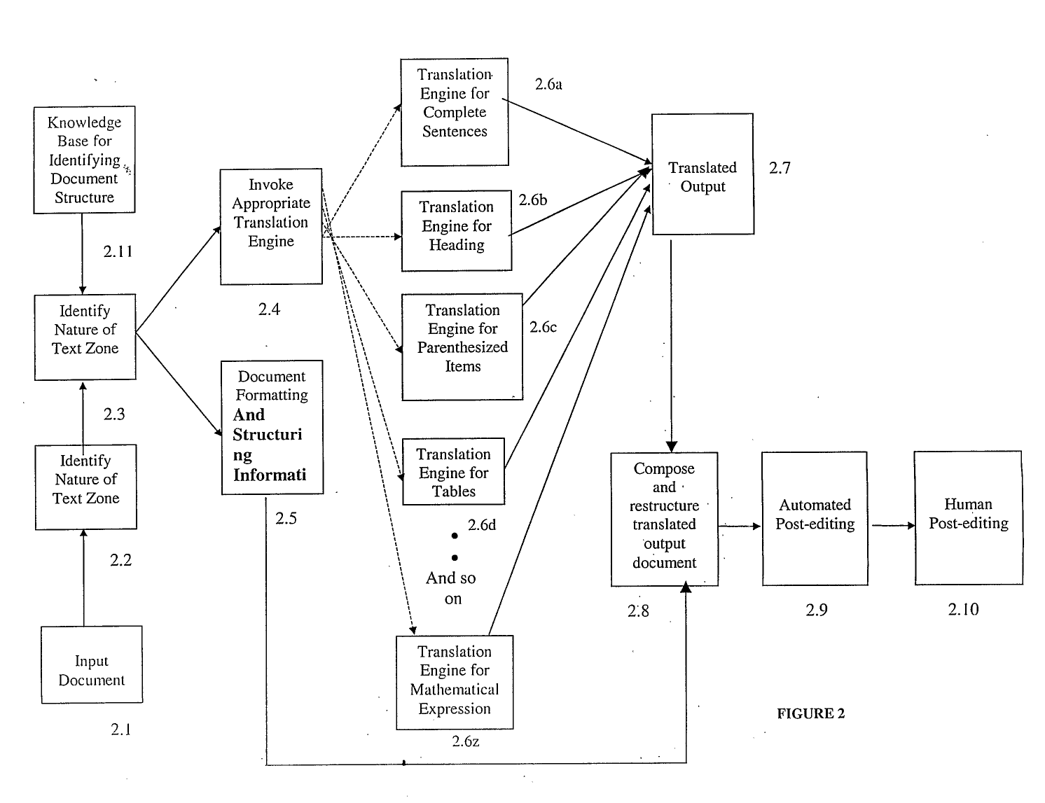

In accordance with the present invention, the translation system comprises a number of modules that communicate with each other. FIG. 2 depicts a block schematic of the overall system of the present invention. A module (2.1) inputs text from a source file that can contain text from a plurality of sources including fax, e-mail, optical scanner, web page, character recognition, speech recognition and the like. Module (2.2) extracts the various text zones from the text input and subsequently, another module (2.3) identifies the nature of the text zones. The text zones are based on such criteria as running text with full sentences, running text with partial sentences, address, text heading, news heading, mathematical expression, table, transcripted speech text, text in mixed languages such as English and Hindi, parenthesized items, items within quote marks. footnotes and the like using a knowledge base (2.11). The knowledge base (2.11) primarily consists of heuristics on document structures.

Various text translation engines are provided by the invention based on the nature of the identified text zone. Therefore, after the text nature has been identified by module (2.3), the appropriate translation engine is invoked (2.4). The different translation engines (2.6a, 2.6b . . . 2.6z) differ in their grammar formalism and example-base. For example, “DDA Flats” will get translated differently in an address field. Similarly news heading “eleven die in flash flood” will get translated in the past tense in Hindi.

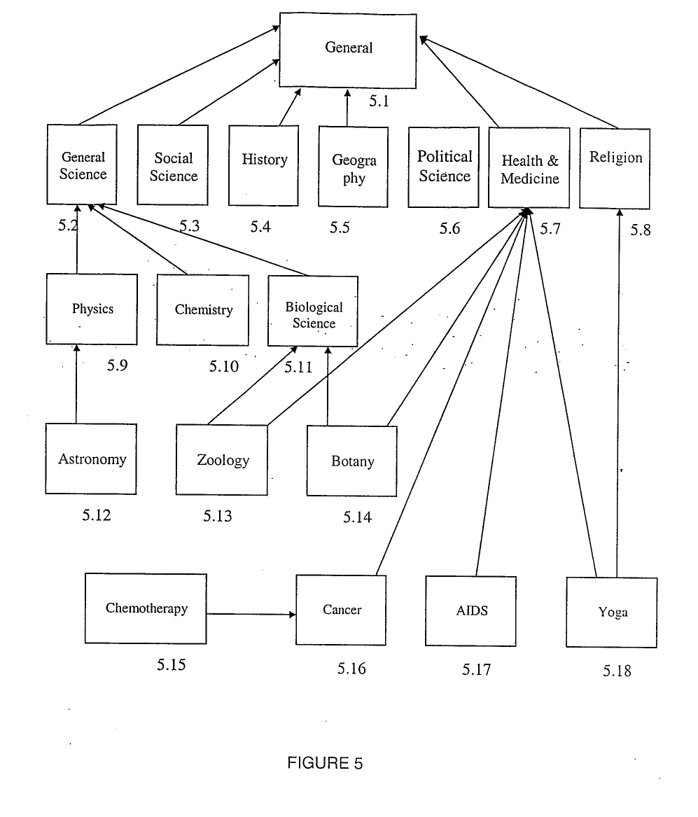

The translated output (2.7), as obtained from the target language text generator (explained later in FIG. 5) is composed and re-structured into an output document (2.8) using the document formatting and structuring information (2.5) extracted by module (2.3). A further improvement in the presentation style and accuracy of the translated output is done by means of an automated post-editing module (2.9). An example of such an improvement is treating nouns/pronouns used to address persons held in respect as plurals in a target language even though they may be used as singular in the English text. This is a peculiarity of all Indian languages. For example, the English word “you” will be translated to, “turn” or “aap” in Hindi based on whether you hold the addressed person in respect and honor or not. This correction module embodies a number of heuristics to yield a more acceptable and natural form of the output text. In case some ambiguities remain unresolved at the end of the text generation process, a human engineered post-editing interface (2.10) is provided for the user of the invention to make the desired corrections.

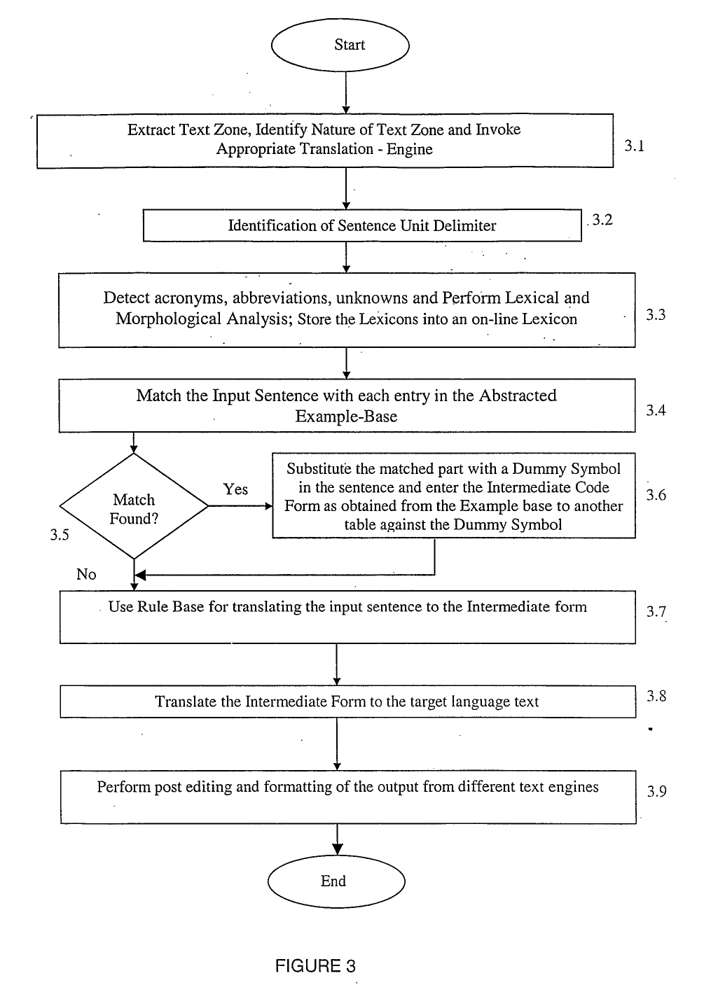

FIG. 3 depicts a flow chart explaining the translation method of the invention. The process is initiated by extracting the text zones from the inputted text document, identifying the nature of each text zone and invoking the appropriate translation engine for each text zone based on its nature (3.1). The next step is to identify the sentence unit delimiter (3.2) for yielding a full or partial sentence as obtained in the identified text zone. The translation engine performs a lexical and morphological analysis (3.3) of each word in the full or partial sentence and in the process also identifies the acronyms, abbreviations and unknown words that may be present. The analysed lexicons are stored into an online lexicon to reduce the search time for any subsequent searches. The online lexicon list is initialized with the most frequently occurring domain specific words, acronyms, names etc. at the start up time and expanded as the translation process goes on.

Following this an Abstracted example base is used for matching the analysed input sentence with each entry on the Left hand side of the Example base (3.4) containing words, phrasals and sentences in the English language. The corresponding Right hand side entries contain the translated entries in the pseudo-interlingua language. If a match is found then the matched part of the input sentence is replaced with a dummy symbol and an intermediate form corresponding to the symbol as obtained from the example base is entered into another table against the symbol (3.6). If a match is not found (3.7), then a rule base is used to convert the input sentence to the intermediate form. In case the entire input sentence matches with the example base, the rule-base module will simply find a dummy symbol and the rule-base only substitutes the stored intermediate form against the dummy symbol as its output.

The intermediate form, thus obtained, is converted to the target language text using a text language generator (3.8) following which an automated post editing (3.9) is provided to improve the accuracy of the text output and also to improve its style of presentation. A human engineered post editing interface (3.9) is also provided to allow the user to remove any ambiguities that may remain after the automated post editing is over.

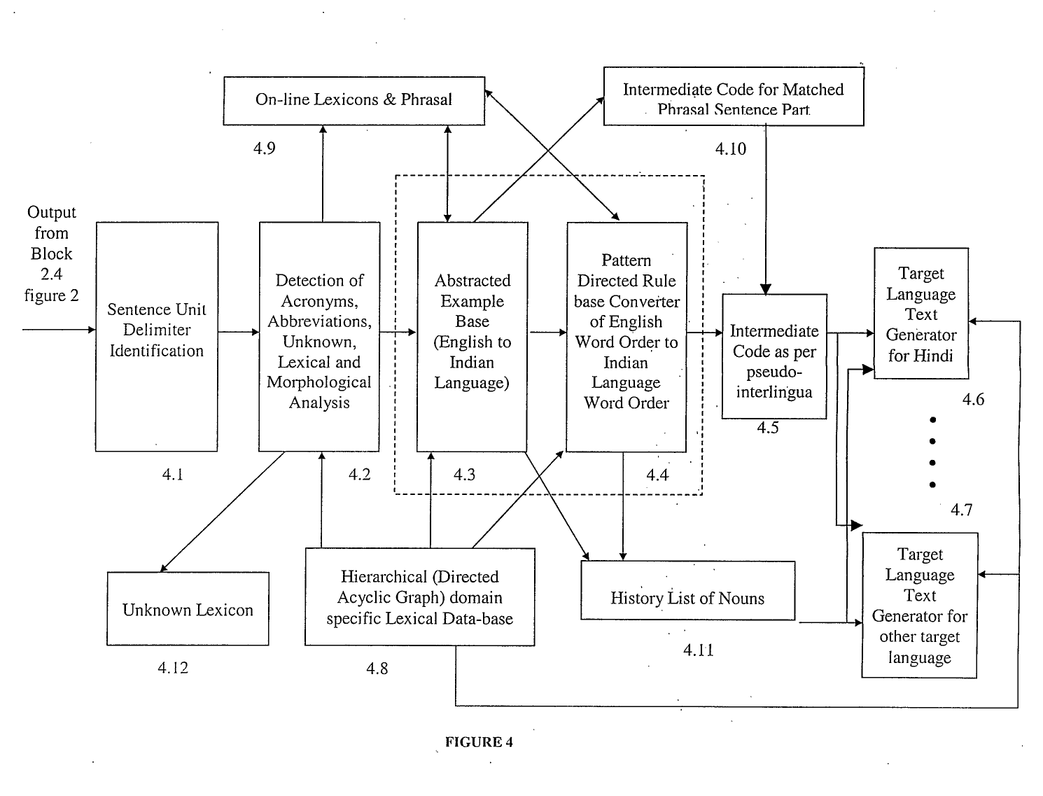

FIG. 4 shows a block schematic of the module embodying main-translation engine of the present invention. The module (4.1) receives its input from the module (2.4) that invokes the appropriate translation engine based on the nature of the text and identifies the sentence delimiter yielding a full sentence or a partial sentence as obtained in the identified text-zones. This module also records the input formatting information that is used for formatting the target language text as obtained from the translation system.

The module (4.2) embodies algorithms for detecting acronyms and unknown words (4.12) and also, performing lexical and morphological analysis for each input word to facilitate search in the abstracted example database (4.3). The lexicons along with their properties, acronyms and unknown words with postulated tags, are stored in the on-line lexicons and phrasals module (4.9) to reduce the search time for each subsequent search. For a subsequent lexicon search, this module is searched first and if the lexicon is not found online it is later searched in the lexical database.

The module (4.3) is an abstracted example-base storing examples of source to target language translations. These examples are the most commonly encountered phrases, groups of words, or full or partial sentences in the target language. The examples can be stored in raw form, i.e. the form in which they actually occur, or in an abstracted form where the individual words or groups of words may be replaced by their categories along with their properties. An abstracted example-base makes the database compact as a number of actual examples may match a single entry in the target language. An example can be used to clarify the difference between an entry in the raw form and in the abstracted form stored in the example base (4.3). The sentence “Ram goes to Delhi” is in the raw form as it is used in the source language, i.e., English. However, the basic structure of the sentence can be abstracted to the form “<NP1> <verb2-movement-type> to {City}”. In other words, the constants in a sentence can be replaced with variables making it broader and generic. This abstracted form can be stored in the example base and thereafter; any other sentence that uses the same structure such as “Fred goes to London” can be translated using this abstracted form. Another example of a sample entry in the abstracted example-base may be “inspite of <NP 1> being <PP2> {place} $ADV$→<NP1><PP2>K5 {BE verb5} {inspite of}”. This will match a number of sentence fragments such as “inspite of me being there’ or ‘inspite of a lot of people being at the premises of the court’ or ‘inspite of John and Mary being here’ and so on. Thus, this approach helps to reduce the storage space requirements of the database and increase its efficiency.

An example in the example-base consists of two parts: Left-hand side (source language part) contains English words and variables (which could be substituted by only an English word or a group of words, that satisfy the properties associated with the variable). The Right-hand side contains the corresponding intermediate form representation as per the word order of the target Indian language.

An input sentence is first matched with the left-hand side of the example base to locate the largest matching chunk of example sentence corresponding to the input sentence. If a match is found above a certain threshold minimum distance value, the intermediate form on the right hand-side of the matching example is stored against a distinct dummy variable name by the module (4.10). At the same time, part of the sentence that matched with the example-base, is substituted with the distinct dummy variable name along with the properties of that component as obtained from the example-base.

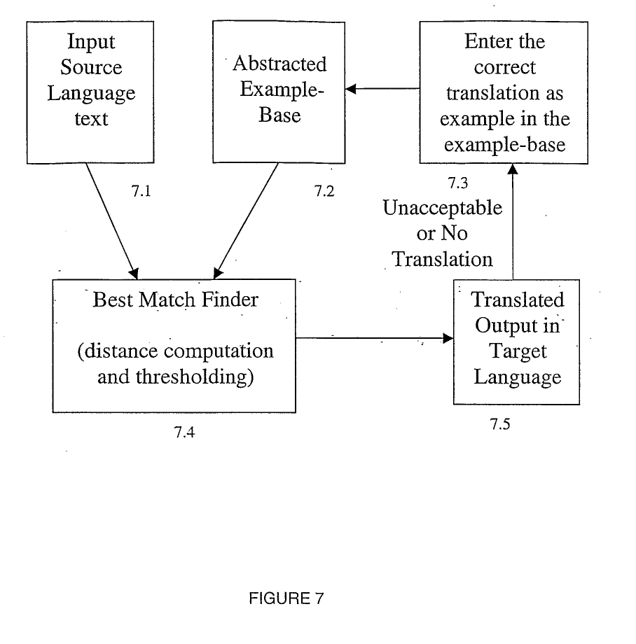

The example-base can be created interactively using the translation system of this invention as depicted in FIG. 7 and/or by using a bilingual corpora. The example base can be further expanded by incorporating new examples in the source language along with their corresponding translation in the target language for improving the quality of the translation. Statistical information can be used for more efficiently expanding the database based on the frequency of occurrence of phrases in the source language. The most often occurring phrases can be tracked and added to the example base in this manner. The quality of translation is improved as the examples capture the contextual information under which meanings of a word or word groups may differ. Different contexts lead to distinct examples in the example-base leading to minimal or no effort in disambiguation in obtaining the translation.

A Pattern directed rule-based converter module (4.4) transforms the input sentence of the source language to an intermediate form based on the grammatical pattern of the input sentence. A rule is invoked when the grammatical pattern matches that of the input sentence. This matching may be performed recursively and multiple matches yield multiple translations. For each match there is a corresponding intermediate form. The intermediate form contains all the information obtained from the lexical date-base and has the word order as per target Indian language. The intermediate form is pseudo-interlingua for Indian languages.

The two modules (4.3, 4.4) together form the heart of the text translation engine of the system and ensure hybridization of example-based and rule-based methodologies. The hybridization method presented in this invention attempts to get the best results from both the methodologies. When a source language text is being translated, the system of this invention, first uses the example-base and then the rule-base for translation for remaining unmatched part, if any. On the other hand, at the time of system development, the example base is expandable in an user interactive manner. The input sentence is first translated using the pattern directed rule base and if the translation is found unsatisfactory, then the sentence is added to the example base in the abstracted form. In this way, the example base grows over a period of time and starts bending towards saturation. This is further illustrated in FIG. 7.

The output of the Pattern directed rule base or the example base is an intermediate form (4.5).

All nouns encountered by modules (4.3,4.4) are stored in a history list of nouns (4.11) that is used for resolving pronoun reference ambiguity.

The hierarchical domain specific multilingual lexical database (4.8) is organized as Directed Acyclic Graph (DAG) linking domains with sub-domains. This is further illustrated through an example in FIG. 5. The structure of the database as depicted in FIG. 5 is only for illustrative purposes and it may be expanded by adding new domains and sub-domains if required. The structure of the multilingual lexical database helps to reduce the sense ambiguity of the words in an input sentence.

The text generator modules (4.6, 4.7), each provided for a particular target language, takes the intermediate form generated by the rule base module (4.5) and also as obtained from the example base (4.10) and converts it into the unstructured target language text output.

FIG. 5 depicts an example of Domain Hierarchy in the form of DAG (Directed Acyclic Graph) used in the present invention. The top node of the DAG is the ‘General’ domain (5.1) that contains the words and phrases not belonging to any particular specialised sub domain. The sub domains at the next level in the hierarchy are broad domains such as General science (5.2), Social science (5.3), History (5.4), Geography (5.5), Political science (5.6), Health and medicine (5.7), Religion (5.8) and others like these. A domain at this level might have more specialised sub domains, for example, the General science (5.2) domain can have 3 sub domains namely Physics (5.9), Chemistry (5.10) and Biological science (5.11). The Biological science (5.11) sub domain can further have even more specialised sub domains as Zoology (5.13) and Botany (5.14). One or more parent domains can share the specialised sub domains. For example, Zoology (5.13) and Botany (5.14) sub domains are shared by Biological science (5.11) and Health and medicine (5.7) parent domains. The domain hierarchy as described herein is meant for illustrative purposes only and is not a limitation of the hierarchical multilingual database used by the invention. It can be easily scaled up to include more domains and sub domains and expand the hierarchy.

When the domain of the text to be translated is identified, the system looks for lexical entries in the identified domain. For example, if the identified domain is Botany (5.14), the system searches this domain for any lexical entries to be matched. If it does not find an entry in this domain, the lexical entries in the parent domains of Biological science (5.11) and Health & Medicines in the hierarchy are searched in parallel. If the entries are still not found then the hierarchy is searched all the way up to the ‘General’ domain (5.1), that is searched in the end. The lexical database organized in this fashion helps in disambiguating meanings of the words in the input text that is a specific object of the system. As an example, if a user is translating text from Health and medicine domain (5.7), a word such as ‘treatment’ will get assigned the meaning in the sense of ‘behaviour’ (in Hindi: ‘vyavahaar’).

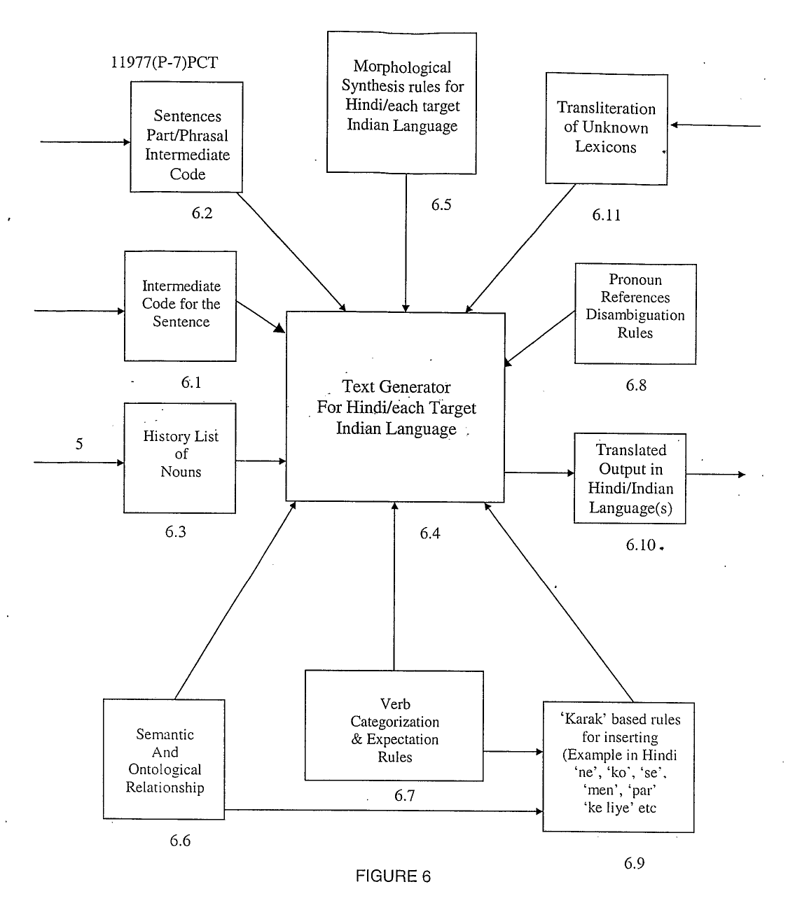

FIG. 6 is a block schematic of inputs used by the Text Generator Module for Hindi or other target Indian languages in the present invention. The text generator module takes as its inputs: an intermediate code for sentences (6.1) and sentence part/phrasal intermediate code (6.2). The text generator uses verb categorization-and expectation rules (6.7), semantic, ontological (6.6) and morphological composition information (6.5) and a number of rules derived from Sansktit ‘Karak’ theory (6.9) to synthesize text in the target Indian language leading to a more acceptable ‘parsarg’ symbols (post-positions) and help disambiguation. The pronoun reference disambiguation is achieved using a history list of nouns (6.3) and disambiguation rules (6.8). The unknown lexicons are transliterated into the script of the target language (6.11) and suitably transformed as per their guessed part of speech in the target language. For example, assume that an English verb “abort” is not present in the lexical database and the input sentence encounters the word “aborted” in the input sentence. This module will take the meaning of “aborted” as “ebaurt kar” in lindi (“ebaurt” is transliterated form of word “abort” and “kar” is appended to obtain its form) if the unknown lexicon is guessed to be a verb in past tense. The final transliterated form for this part as per rules of composition will be “ebaurt kiyaa” which is quite an acceptable form in day-to-day usage in India. The output of the text generator module is the translated text in the target language (6.10).

FIG. 7 shows a Block schematic illustrating the interactive method of Example-base creation used in this invention. The input source language text (7.1) is matched with the entries of the abstracted example-base (7.9) by the Best-Match-Pinder module (7.4). The best match finder module computes distance of the input source language text with each entry of the abstracted example-base available with the system at the time of development. This distance computation is based on aggregated (weighted sum) distances of attributes/properties associated with individual constituent symbols/words of the source and example texts. This distance is compared with a preset threshold (a parameter leant by the system during experimentation) and a translation is produced (7.5) only when the computed distance is less than the threshold value. For efficient searching of the example-base, the example-base is portioned in a logical manner and the search is confined to a partition or partition hierarchy. When the system developer does not find the translated output to be satisfactory or there is no translation produced due to thresholding, the system developer enters the correct translation as an additional example in the example-base (7.3). This way the system's example-base grows with exposure to more and more user interaction during the development stage and the curve of example-base growth starts showing a bending. The system developer may decide an appropriate level of saturation for the system delivery for actual usage.

1-40. (canceled)

41. A method for translating a source language into a target language comprising the steps of:
identifying the nature of text extracted from a source document;
filtering and storing the text formatting and structure information of the extracted text;
selecting an appropriate text translation engine based on the nature of the extracted text;
using the text translation engine for analyzing and translating the extracted text into an unformatted translated text; and
using the stored text formatting and structure information to process the unformatted text for obtaining a structured translated text document in the target language.

42. The method as claimed in claim 41 further comprising the step of performing post editing on the structured translated text document for improving the accuracy of the translation and its presentation style.

43. The method as claimed in claim 42 wherein the post editing step is performed automatically on the structured translated text document for removing target language specific ambiguities and errors that maybe present.

44. The method as claimed in claim 42 wherein the post editing step is performed by a manually on the structured translated text document for removing ambiguities and errors that maybe present.

45. The method as claimed in claim 41 wherein nature of the extracted text is identified by a source language specific base includes running text with full sentences, running text with partial sentences, address, text heading, news heading, mathematical expression, table, a transcripted speech text, a text in mixed languages, footnotes, text within quote marks, parenthesized items and like.

46. The method as claim 41 wherein text portions having different nature are translated using different text translation engines.

47. The method as claimed in claim 41 wherein the step of analyzing the extracted text comprises the steps of:
identifying the sentence unit delimiter of the extracted text for breaking the text into separate sentences;
performing the lexical analysis on each word of the sentence using a domain specific lexical database for disambiguating the meaning and identifying acronyms;
abbreviations and unknown words in the sentence by identifying their domain, and storing the analyzed words (lexicons) along with their properties in an online-lexical and phrasal database and storing the unknown lexicons in a separate database for increasing the translation speed.

48. The method as claimed in claim 41 wherein the step of translating the extracted text comprises the steps of:
converting the analyzed text or a part of it to an intermediate form; and
translating the text in the intermediate form to the unformatted translated text said translation uses an abstracted example base comprising commonly encountered phrases, groups of Words and sentences.

49. The method as claimed in claim 48 wherein the analyzed text is compared with the entries in the abstracted example base and is substituted with its corresponding translation in the pseudo- interlingua, when a match is found, to obtain an intermediate translated text.

50. The method as claimed in claim 48 wherein the example base is expanded by adding new entries based on users' feedback on accuracy of the obtained translated output for improving the quality of the translation, wherein the example base can be expanded by adding new entries based on statistical information regarding the frequency of occurrence of the phrases in the source language for improving the quality of the translation.

51. The method as claimed in claim 48 wherein a rule based translation is done for the text or part of the text that are not present in the abstracted example base to obtain an intermediate translated text.

52. The method as claimed in claim 48 wherein a target language text generator is used for translating the intermediate text to the unformatted target language text wherein the text generator performs at least one of the following steps for translating the text in the intermediate form to the target language:
morphological synthesis of different lexicons for the target language, transliterating the unknown lexicons, generating an appropriate form for unknown lexicons in the target language;
establishing semantic and ontological relationship, using the history list of nouns and related rules for pronoun reference disambiguation, and composing and restructuring the target language document using the stored text formatting and structure information to obtain a structured translated text document.

53. A system for translating a source language into a target language comprising:
means for identifying the nature of text extracted from a source document wherein the source document includes a language specific knowledge base;
means for filtering and storing the text formatting and structure information of the extracted text;
means for selecting an appropriate text translation engine based on the nature of the extracted text;
means for analyzing and translating the extracted text into an unformatted translated text, using text specific translating engines, said translating and analyzing means further comprising:
means for identifying the sentence unit delimiter of the extracted text for breaking the text into separate sentences;
means for performing the lexical analysis on each word of the sentence; and
means for storing the analyzed words (lexicons) along with their properties in an online-lexical and phrasal database and storing the unknown lexicons in a separate database for increasing the translation speed maintaining a history of nouns for resolving pronoun reference abiguity; and
means for using the stored text formatting and structure information to process the unformatted text for obtaining a structured translated text document in the target language;
optionally comprising editing means for performing post editing on the structured translated text document for improving the accuracy of the translation and its presentation style.

54. The system as claimed in claim 53 wherein means for performing the lexical analysis is a hierarchical domain specific multilingual database that can be expanded by adding new domains and domain specific words, said hierarchical domain specific multilingual database is organized as a Directed Acyclic Graph linking domains and sub-domains and stores verbs and nouns using paradigm coding for morphological synthesis rules in translation.

55. The system as claimed in claim 53 wherein means for translating the lexicons into an intermediate text is an expandable abstracted target language specific example base comprising commonly encountered phrases, groups of words and sentences.

56. The system as claimed in claim 53 further comprising rule based translating means for translating the text or part of text not present in the abstracted example base into an intermediate text.

57. The system as claimed in claim 55 wherein means for translating the intermediate text to the target language text is a target language text generator, said target language text generator comprises:
means for morphological synthesis of different lexicons for the target language, means for transliterating the unknown lexicons;
means for generating an appropriate form for unknown lexicons in the target language, means for establishing semantic and ontological relationship, means for using the history list of nouns and related rules for pronoun reference disambiguation; and
means for composing and restructuring the target language document using the stored text formatting and structure information to obtain a structured translated text document.

58. The system as claimed in claim 53 wherein the computing system nodes for translating a source language into a target language comprises: at least one system bus, at least one communication unit connected to the system bus, at least one memory unit connected to the system bus, wherein the memory includes a set of instructions, and at least one central processing unit connected to the system bus, wherein the central processing unit executes the instructions in the memory for translating a source language into a target language said system further connected to other similar systems and that may contain means to complement and supplement the aforementioned means.

59. A computer program product comprising computer readable program code stored on computer readable storage medium embodied therein for translating a source language into a target language, comprising:
computer readable program code means configured for identifying the nature of text extracted from a source document;
computer readable program code means configured for filtering and storing the text formatting and structure information of the extracted text;
computer readable program code means configured for selecting an appropriate text translation engine based on the nature of the extracted text;
computer readable program code means configured for analyzing and translating the extracted text into an unformatted translated text;
computer readable program code means configured for using the stored text formatting and structure information to process the unformatted text for obtaining a structured translated text document in the target language;
computer readable program code means configured to expand the example-base interactively; and
computer readable program code means configured to derive abstracted examples from the raw examples.

60. The computer program product as claimed in claim 59 further comprising computer readable program code means configured for performing post editing on the structured translated text document for improving the accuracy of the translation and its presentation style.
